(19) United States
(12) Patent Application Publication
(10) Pub. No.: US 2026/0011949 A1
(43) Pub. Date: Jan. 8, 2026

(54) Connector Assembly

(71) Applicant: Molex, LLC, Lisle, IL (US)

(72) Inventors: Jie Wu, Chengdu (CN); Bai Hu, Chengdu (CN); Zhi-Peng Fan, Guangyuan (CN); Guillaume Michel Aimé Simon, Meudon (FR); Francois André Jean Cullard, Trappes (FR); Olivier Marcel Raymond Plessis, Guyancourt (FR); Wafa Ammar, Villeneuve la Garenne (FR); Olivier Alain Verchere, Juvisy-Sur-Orge (FR)

(21) Appl. No.: 19/238,569

(22) Filed: Jun. 16, 2025

(30) Foreign Application Priority Data
Jul. 2, 2024 (CN) 202410878231.6

(51) Int. Cl. H01R 13/516; H01R 13/629

(52) U.S. Cl. CPC H01R 13/516; H01R 13/62955

(57) ABSTRACT

A connector assembly is used to mate with a mating connector, the connector assembly includes a connector, the connector includes a plurality of terminal modules and a connector housing, each terminal module is provided with at least one guiding rib protruding therefrom, the connector housing forms a plurality of receiving chambers which are used to respectively receive the plurality of terminal modules, each receiving chamber is formed with a guiding groove and an opening segment which correspond to the guiding rib, by that the guiding groove guides the guiding rib of the terminal module, each terminal module is received in one receiving chamber, and the guiding rib at least partially extends out of the opening segment. A connector assembly is further provided in which a lever and a cover may cooperate with need or limitation of a practical circumstance to be selectively assembled to a connector so as to change an assembling direction of the lever and the cover.

### TECHNICAL FIELD

The present disclosure relates to a connector assembly, and particularly relates to a harness connector assembly.

### BACKGROUND

Chinese patent document CN214957583U discloses a lever connector which may be reversely assembled, such a type of the connector is a vehicle harness connector, and mainly includes a connector housing, a cover, a wire exiting head housing, sliders and a lever, by that first protrusions of the wire exiting head housing and circular arc recessed grooves of the sliders cooperate with each other, the connector provides that the cover and the lever may be mounted in different directions.

### SUMMARY

An object of the present disclosure is to provide a connector assembly which is different from the prior art.

Another object of the present disclosure is to provide a connector assembly in which a cover and a lever may cooperate with a mating connector to change an assembling direction of the cover and the lever.

A connector assembly of the present disclosure comprises a connector, the connector comprises a plurality of terminal modules and a connector housing, each terminal module is provided with at least one guiding rib protruding therefrom, the connector housing forms a plurality of receiving chambers which are used to respectively receive the plurality of terminal modules, each receiving chamber is formed with a guiding groove and an opening segment which correspond to the guiding rib, by that the guiding groove guides the guiding rib of the terminal module, each terminal module is received in one receiving chamber, and the guiding rib at least partially extends out of the opening segment.

In an embodiment, the connector assembly further comprises a mating connector, the mating connector is formed with a plurality of mating regions which are respectively used to correspond to the plurality of terminal modules respectively in the plurality of receiving chambers, each mating region is formed with a mating guide groove which corresponds to the guiding rib.

In an embodiment, the opening segment of each receiving chamber has a tip, the guiding rib of the terminal module abuts against the tip of the opening segment.

In an embodiment, the connector housing comprises two side walls which face each other, two connecting walls which connect the two side walls and a plurality of partitioning walls, the plurality of partitioning walls are provided between the two side walls and the two connecting walls, the plurality of partitioning walls and the two side walls and the two connecting walls cooperate with each other to define the plurality of receiving chambers which are used to respectively receive the plurality of terminal modules, the guiding grooves and the opening segments are provided to the two connecting walls and the plurality of partitioning walls and correspond to each other.

In an embodiment, each terminal module is provided with the two guiding ribs protruding therefrom, the two guiding ribs respectively protrude from two opposite sides of the terminal module, each receiving chamber of the connector housing has the two guiding grooves and the two opening segments.

In an embodiment, each terminal module comprises an insulative body and terminals which are mounted to the insulative body and are used to be connected with wires respectively, the connector assembly further comprises a cover which is mounted to the connector housing, the cover comprises a pair of side plates, and the pair of side plates define an opening portion therebetween, the opening portion extends by an angle range and allows the wires to extend out of the opening portion from different angles in the angle range.

In an embodiment, each side plate is provided with multiple holes, which are in different positions, along the angle range, the holes are used to allow partitioning elements to pass through the holes of the side plates so as to limit directions of the wires which extend out of the opening portion.

In an embodiment, the opening portion comprises a side opening region and a top opening region which are communicated with each other to be in form of L-shape, the multiple holes are distributed from the side opening region to the top opening region.

In an embodiment, each terminal module comprises an insulative body and a latching arm and a latching groove which are provided to at least one of two opposite sides of the insulative body, each latching arm has a tip hook which is toward the latching groove of the insulative body and is used to latch into the latching groove.

In an embodiment, each receiving chamber of the connector housing is formed with a position-limiting structure, each terminal module further comprises a position-limiting portion which is formed to an outer side of the insulative body, when the terminal module is received in the receiving chamber, the position-limiting structure and the position-limiting portion cooperate with each other to limit the terminal module to be detached from the receiving chamber.

A connector assembly of the present disclosure comprises a connector, the connector comprises a connector housing, a plurality of terminal modules, a lever and two driven elements, the connector housing comprises two side walls which face each other, each side wall is provided with two connecting axles protruding therefrom and spaced apart from each other, the two connecting axles are symmetric with respect to a symmetry axis which passes through between the two connecting axles, the plurality of terminal modules are provided to the connector housing, the lever is provided to the connector housing and is capable of being operated to rotate relative to the connector housing, the lever comprises two driving elements which each are used to be mounted to one of the two connecting axles of the each side wall, each driving element comprises a driving gear portion, the two driven elements each are used to be provided to the other of the two connecting axles of the each side wall, each driven element comprises a driven gear portion which is used to mesh the driving gear portion.

In an embodiment, each side wall comprises two halves which are symmetric with respect to the symmetry axis, each half contains one connecting axle, the two connecting axles allow the lever to be capable of being selectively provided to one of the two halves and allow the driven element to be provided to the other of the two halves.

In an embodiment, the connector assembly further comprises a mating connector, the mating connector comprises two outer side walls which are spaced apart from each other, and four mating mesh portions which are provided to the two outer side walls, each outer side wall is provided with the two mating mesh portions, and each driving element of the lever further comprises a driving mesh portion, each driven element further comprises a driven mesh portion, the two mating mesh portions of each outer side wall are respectively used to mesh the driving mesh portion of the driving element and the driven mesh portion of the driven element.

In an embodiment, the driving mesh portion of the driving element and the driven mesh portion of the driven element each are one of a tooth-profile structure and a tooth space structure, the two mating mesh portions each are the other of the tooth-profile structure and the tooth space structure.

In an embodiment, each terminal module comprises an insulative body and terminals which are mounted to the insulative body and are used to be connected with wires respectively, the connector assembly further comprises a cover which is mounted to the connector housing, the cover comprises a pair of side plates, and the pair of side plates define an opening portion therebetween, the opening portion extends by an angle range and allows the wires to extend out of the opening portion from different angles in the angle range.

In an embodiment, ach side plate is provided with multiple holes, which are in different positions, along the angle range, the holes are used to allow partitioning elements to pass through the holes of the side plates so as to limit directions of the wires which extend out of the opening portion.

In an embodiment, the opening portion comprises a side opening region and a top opening region which are communicated with each other to be in form of L-shape, the multiple holes are distributed from the side opening region to the top opening region.

In an embodiment, each side wall of the connector housing is further provided with two stopping protrusions protruding therefrom and spaced apart from each other, the two connecting axles are positioned between the two stopping protrusions, and the two stopping protrusions are symmetric with respect to the symmetry axis.

In an embodiment, the connector further comprises a cover which is mounted to the connector housing, the cover comprises a locking structure, the lever further comprises a body and a locking member provided to the body, and the lever is operable to rotate relative to the connector housing to a pre-mounting position where the lever is away from the cover and a pressing position where the lever presses against the cover, when the lever is in the pressing position, the lever is capable of being in a first locking state, and the locking member is capable of being operated to cooperate with the locking structure so that the lever is further in a second locking state.

In an embodiment, the cover further comprises a pair of side plates and a top plate connecting the two side plates, the locking structure is provided to the top plate, and comprises an elastic pressing plate which is provided to the top plate and a first locking portion and a second locking portion which are provided to the elastic pressing plate, the lever further comprises a third locking portion which is provided to the body, the locking member comprises a locking body which is movably provided to the lever and a fourth locking portion which is provided to the locking body, when the lever is operated to rotate to be in the pressing position and the lever is in the first locking state, the third locking portion of the locking member is stopped by the first locking portion in a direction that the third locking portion of the locking member rotates back to the pre-mounting position, when the locking member is operated to displace to make the fourth locking portion latch to the second locking portion, the lever is in the second locking state.

In an embodiment, the body of the lever comprises two arm portions and a beam portion which connects the two arm portions, the two driving elements are respectively formed to the two arm portions, the locking member and the third locking portion are provided to the beam portion.

An effect of the present disclosure lies in that: by the guiding ribs of the plurality of terminal modules in cooperation with provision of the opening segments of the connector housing, when the plurality of terminal modules are respectively placed into the plurality of receiving chambers of the connector housing and when the connector inserts into the mating connector, guiding functions may be played.

Another effect of the present disclosure lies in that, with the two connecting axles of the connector housing employ the symmetric arrangement, it allows that the lever may cooperate with need or limitation of a practical circumstance to be selectively assembled to a right side or a left side of the entire connector.

And the cover also may change an assembling direction of the lever based on the requirement on a wire exiting direction, and in cooperation with the holes of the two side plates of the cover which are distributed at different angles, it also may more flexibly adjust the wire exit direction of the wires.

### BRIEF DESCRIPTION OF THE DRAWINGS

Other features and effects of the present disclosure will be apparent from an embodiment with reference to the drawings, in which:

FIG. 1 is a perspective view illustrating that an embodiment of a connector assembly of the present disclosure includes a connector, a lever, driven elements, a cover and a mating connector;

FIG. 2 is a perspective view illustrating a structure of the mating connector;

FIG. 3 is an exploded view illustrating a positional state of the connector, the lever, the driven elements and the cover;

FIG. 4 is an exploded view illustrating a positional state of a connector housing and terminal modules of the connector and the lever and the driven element;

FIG. 5 is a bottom perspective view illustrating that the connector housing includes position-limiting structures;

FIG. 6 is a perspective view illustrating a cooperating state of the connector housing and the terminal modules of the connector with the connector housing partially cut away;

FIG. 7 is a top view illustrating a state of the connector assembly view from the up;

FIG. 8 is a cross sectional view taken along a VIII-VIII line of FIG. 7 and illustrating a state that the terminal modules are respectively received in receiving chambers;

FIG. 9 is a partially enlarged cross sectional view similar to FIG. 8, illustrating terminals of the connector, and illustrating that a tip hook of a latching arm of the terminal module stops in a path that the terminal displaces upwardly;

FIG. 10 is a cross sectional view taken along an IX-IX line of FIG. 7 and illustrating a structure of the cover;

FIG. 11 is a partially enlarged view of a part of FIG. 10 indicated by a circle B;

FIG. 12 is a cross sectional view taken along an XI-XI line of FIG. 7 and illustrating a state that a driving element and the driven element of the lever are mounted to a mating connector housing;

FIG. 13 is a perspective view illustrating the connector mates with the mating connector and the lever is in a pressing position;

FIG. 14 is a partial cross sectional view illustrating the lever in a first locking state;

FIG. 15 is a partially cut away perspective view illustrating the lever in a second locking state; and

FIG. 16 and FIG. 17 are side views illustrating that the cover and the lever may be reversely mounted left and right relative to the connector and the mating connector.

### DETAILED DESCRIPTION

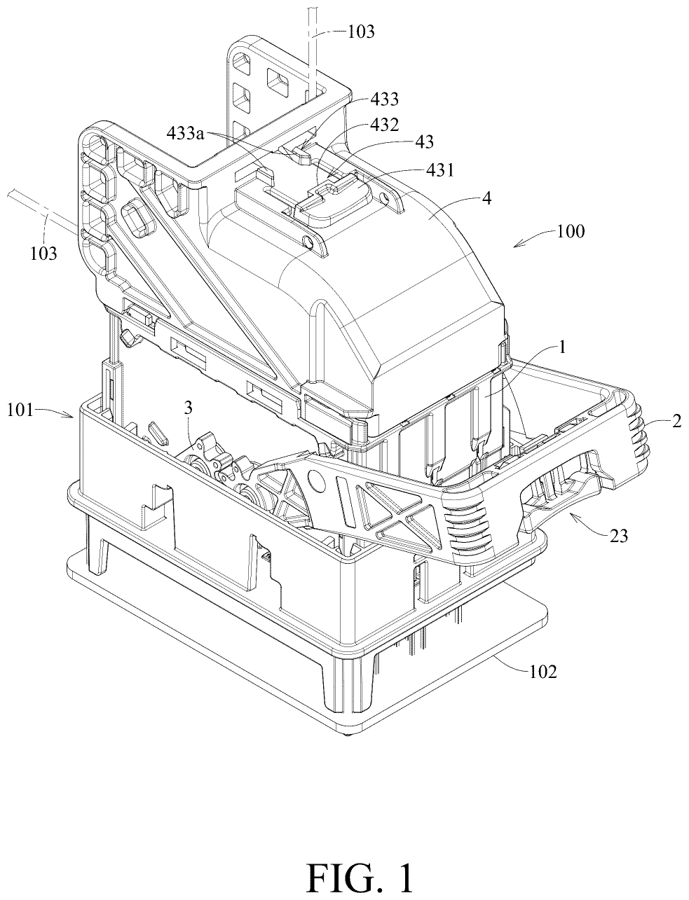

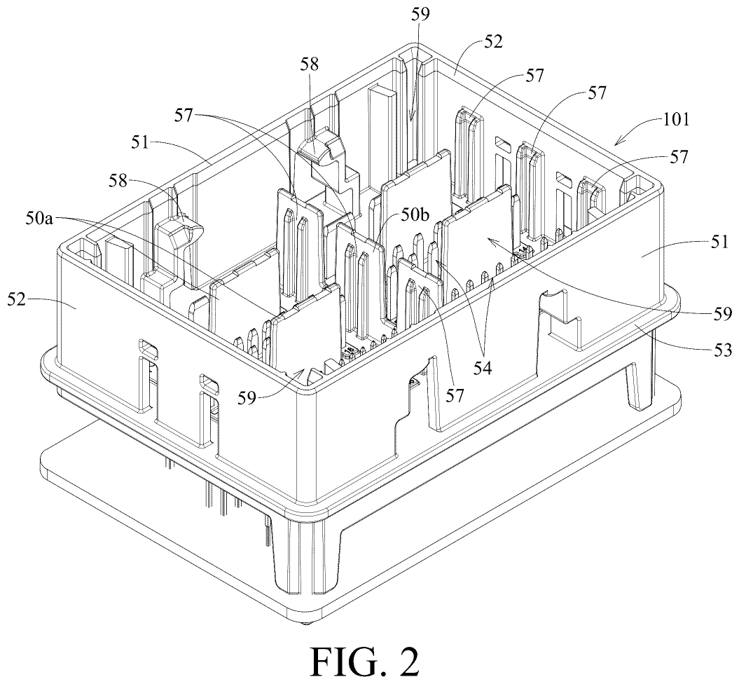

Referring to FIG. 1 and FIG. 2, a connector assembly 100 of the present disclosure is a vehicle harness connector, and is used to mate with a mating connector 101, the mating connector 101 is provided on a circuit board 102.

Referring to FIG. 2, the mating connector 101 includes two outer side walls 51 which are spaced apart from each other, two outer connecting walls 52 which connect the two outer side walls 51, a bottom wall 53, a plurality of first and second partitioning plates 50a, 50b, the two outer side walls 51 and the two outer connecting walls 52 are connected as a rectangular encircling wall structure, the bottom wall 53 is provided with a plurality of groups of terminals 54, the first partitioning plates 50a are interposed between the two outer side walls 51, the second partitioning plate 50b are interposed between the two outer connecting walls 52, and the plurality of first and second partitioning plates 50a, 50b and the two outer side walls 51 and the two outer connecting walls 52 cooperate with each other to define a plurality of mating regions 59, as for the embodiment in the figures, totally define six mating regions 59, the plurality of groups of terminals 54 are respectively positioned in the plurality of mating regions 59. For sake of convenient following description, an orientation where the two outer side walls 51 are presented is defined as a front-rear direction, and an orientation where the two outer connecting walls 52 are presented is a left-right direction. In addition, the mating connector 100 further includes four mating mesh portions 58 which are provided to the two outer side walls 51, each outer side wall 51 is provided with the two mating mesh portion 58. In the present embodiment, the two mating mesh portions 58 are provided to an inner surface of each outer side wall 51, and each are in form of tooth-profile structure, whose function will be described later.

Each mating region 59 is formed with mating guide grooves 57. In the present embodiment, the mating guide grooves 57 are formed on inner wall surfaces of the two outer connecting walls 52 which face each other and two wall surfaces of each second partitioning plates 50b which are opposite to each other and respectively face the two outer connecting walls 52, and, a distributing manner of the mating guide grooves 57 is that, the second partitioning plate 50b and a part of the outer connecting wall 52 which cooperate with each other to define each mating region 59 each are formed with one mating guide groove 57, so that a left side and a right side of each mating region 59 each have the mating guide groove 57. The mating guide groove 57 extends in a vertical direction, and the mating guide groove 57 which is positioned to the outer connecting wall 52 and the mating guide groove 57 which is positioned to the second partitioning plate 50b correspond to each other left and right.

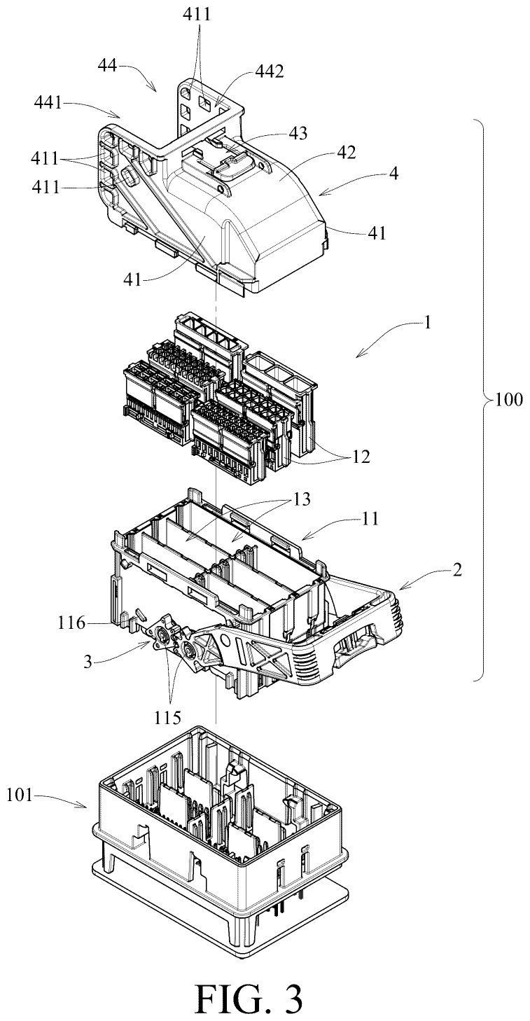

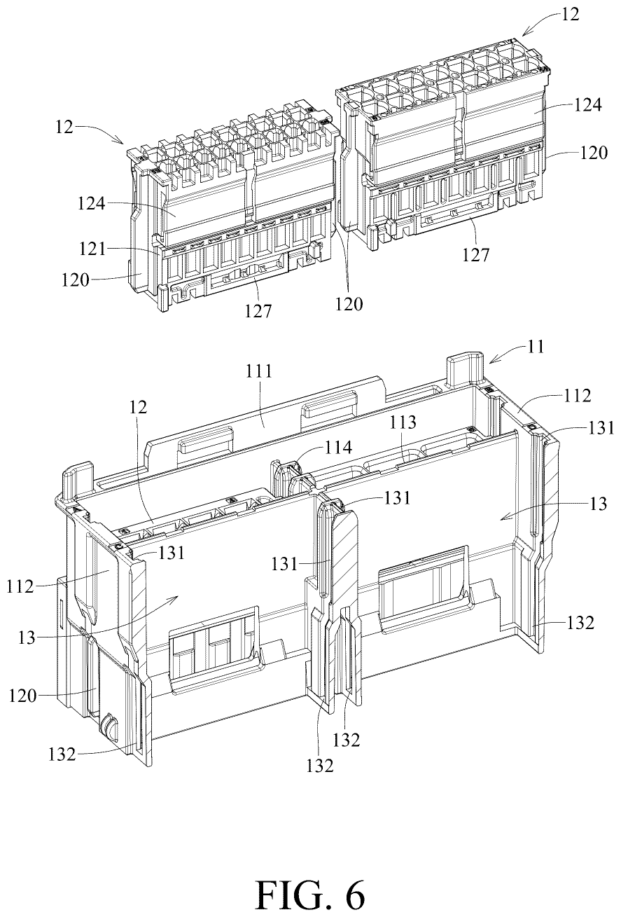

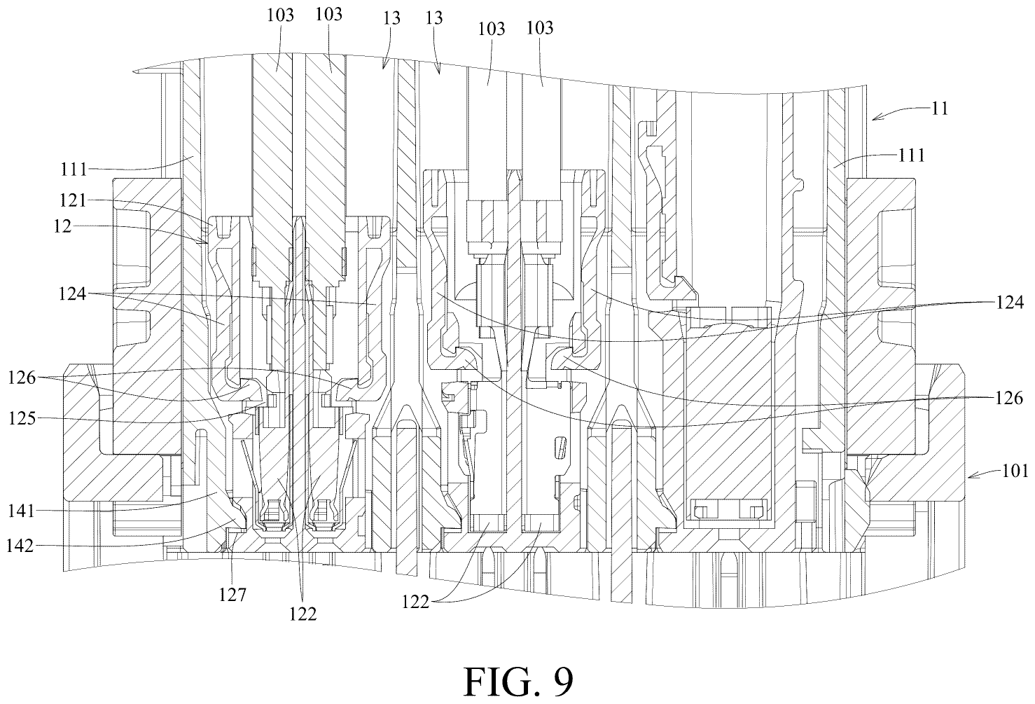

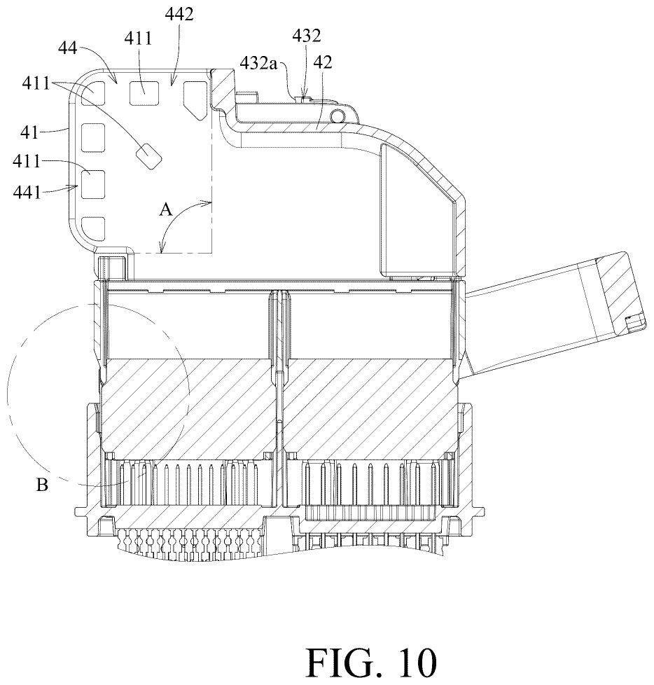

Referring to FIG. 3 to FIG. 6, FIG. 9 and FIG. 10, the connector assembly 100 includes a connector 1, a lever 2, two driven elements 3 and a cover 4. The connector 1 includes a connector housing 11 and a plurality of terminal modules 12. The connector housing 11 forms a plurality of receiving chambers 13 which are used to respectively receive the plurality of terminal modules 12, each receiving chamber 13 form guiding grooves 131 and opening segments 132. In the present embodiment, the connector housing 11 substantially is rectangular and includes two side walls 111 which are spaced apart from each other and face each other, two connecting walls 112 which connect the two side walls 111, and a plurality of partitioning walls 113, 114, the two side walls 111 and the two connecting walls 112 are connected as an encircling wall structure, the plurality of partitioning walls 113, 114 include the first partitioning walls 113 which are parallel to the two side walls 111 and the second partitioning walls 114 which are parallel to the two connecting walls 112, the plurality partitioning walls 113, 114 are provided between the two side walls 111 and the two connecting walls 112 and the plurality partitioning walls 113, 114 and the two side walls 111 and the two connecting walls 112 cooperate with each other to define the plurality receiving chambers 13, as for the embodiment in the figures, totally define six receiving chambers 13 which respectively correspond to the six mating regions 59 of the mating connector 101, each receiving chamber 13 may receive one terminal module 12, and is adapted to receive the terminal module 12 with different specification.

The guiding grooves 131 and the opening segments 132 are formed on inner wall surfaces of the two connecting walls 112 which face each other and two wall surfaces of each second partitioning wall 114 which are opposite to each other and respectively face the two connecting walls 112, and, a distributing manner of the guiding grooves 131 and the opening segments 132 is that, the second partitioning wall 114 and a part of the connecting wall 112 which cooperate with each other to define each receiving chamber 13 each are formed with one guiding groove 131 and one opening segment 132, so that a left side and a right side of each receiving chamber 13 each have the guiding groove 131 and the opening segment 132. The guiding groove 131 extends in the vertical direction, the opening segment 132 similarly extends in the vertical direction and correspondingly penetrates the connecting wall 112 or the second partitioning wall 114, and in the present embodiment, each guiding groove 131 and the opening segment 132 are joined with each other up and down to be positioned in the same straight line, the guiding groove 131 is substantially distributed to a height of an upper half of the connector housing 11, the opening segment 132 is substantially distributed to a height of a lower half of the connector housing 11 and has a tip which is close to a bottom of the connector housing 11, and the guiding groove 131 and the opening segment 132 which are positioned to the connecting wall 112 and the guiding groove 131 and the opening segment 132 which are positioned to the second partitioning wall 114 correspond to each other left and right, a function of the guiding groove 131 and a function of the opening segment 132 will be described later.

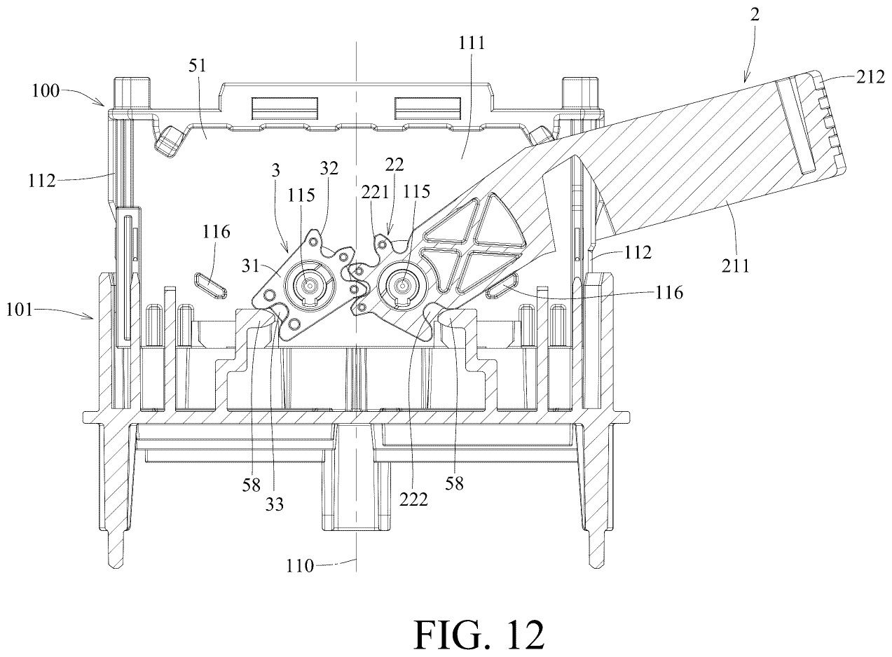

In addition, an outer surface of each side wall 111 of the connector housing 11 is provided with two connecting axles 115 and two stopping protrusions 116 protruding therefrom and spaced apart from each other, the two connecting axles 115 are positioned between the two stopping protrusions 116, the two connecting axles 115 and the two stopping protrusions 116 positioned to the side wall 111 which is in the front protrude forwardly, the two connecting axles 115 and the two stopping protrusions 116 positioned to the side wall 111 which is in the rear protrude rearwardly, and the two connecting axles 115 and the two stopping protrusions 116 of each side wall 111 are provided as left-right symmetry, in other words, as shown in FIG. 12, it presumes that, the two connecting axles 115 and the two stopping protrusions 116 are in left-right symmetry with respect to a symmetry axis 110 which passes through a center of the side wall 111 and between the two connecting axles 115.

Each terminal module 12 is provided with at least one guiding rib 120 protruding therefrom, by that the guiding groove 131 guides the guiding rib 120 of the terminal module 12, each terminal module 12 is received in one receiving chamber 13 of the connector housing 11, and the guiding rib 120 at least partially extends out of the opening segment 132 to be used to cooperate with the mating connector 101. In the present embodiment, each terminal module 12 includes an insulative body 121 and terminals 122 (see FIG. 9) mounted to insulative body 121, the terminal 122 is used to be connected with a wire 103 (see FIG. 9), the wire 103 extends out of a top of the insulative body 121. In the present embodiment, as for the guiding rib 120, a left side and a right side of the insulative body 121 of the terminal module 12 each are provided with the guiding rib 120 protruding outwardly therefrom and extending longitudinally, by that the two guiding rib 120 at the left side and the right side of the terminal module 12 are respectively guided by the two guiding grooves 131, the terminal module 12 is received in one receiving chamber 13 of the connector housing 11, and each guiding rib 120 at least partially extends out of the opening segment 132 to exposed out from the insulative body 121 due to a relationship with the opening segment 132, and a bottom of the guiding rib 120 may abut against the tip of the opening segment 132. In some varied manners, it also may be that, only one of the left side and the right side of the insulative body 121 of the terminal module 12 is provided with the guiding rib 120 protruding therefrom, and correspondingly, only one of the left side and the right side of the receiving chamber 13 is provided with the guiding groove 131 and the opening segment 132.

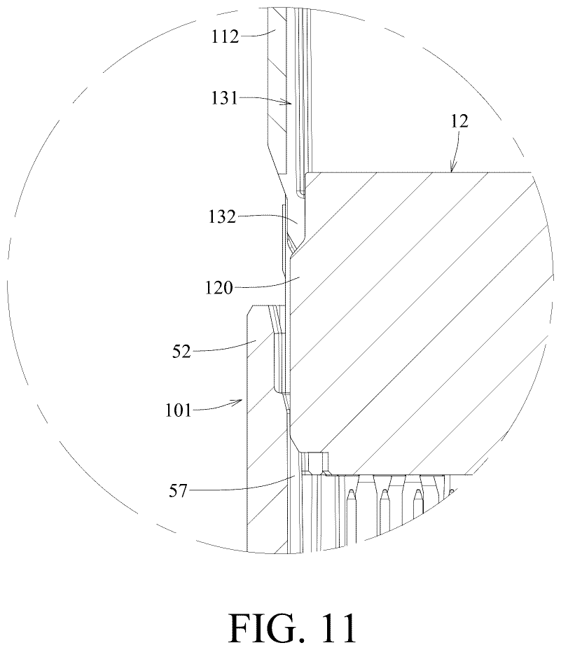

When the connector 100 inserts into the mating connector 101, the six terminal modules 12 positioned in the six receiving chambers 13 respectively insert into the six mating regions 59 of the mating connector 101 and are respectively electrically connected with the terminals 54 of the six mating regions 59, and as shown in FIG. 11, by that the guiding ribs 120 respectively exposed out from the opening segments 132 of the insulative body 121 correspondingly insert into the mating guide grooves 57 of the mating connector 101, the connector 100 may be guided to insert into the mating connector 101, in other words, by provision of the guiding ribs 120 of the terminal module 12 and the opening segments 132 of the connector housing 11, in addition to that the guiding rib 120 of the terminal module 12 may cooperate with the guiding groove 131 to provide a guiding function when the terminal module 12 is placed into the receiving chamber 13 of the connector housing 11, when the connector 100 inserts into the mating connector 101, because the guiding rib 120 will be exposed out via the opening segment 132, the guiding rib 120 may cooperate with the mating guide groove 57 of the mating connector 101 to play a guiding function again.

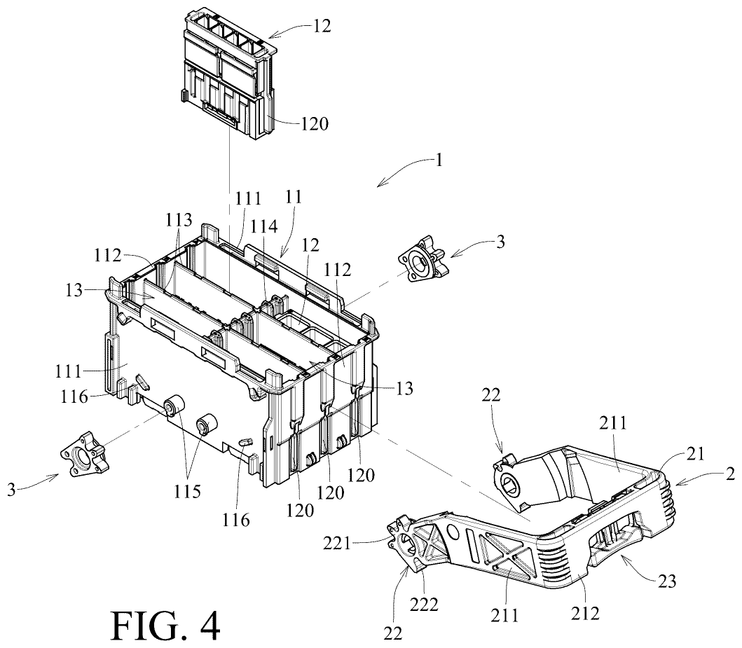

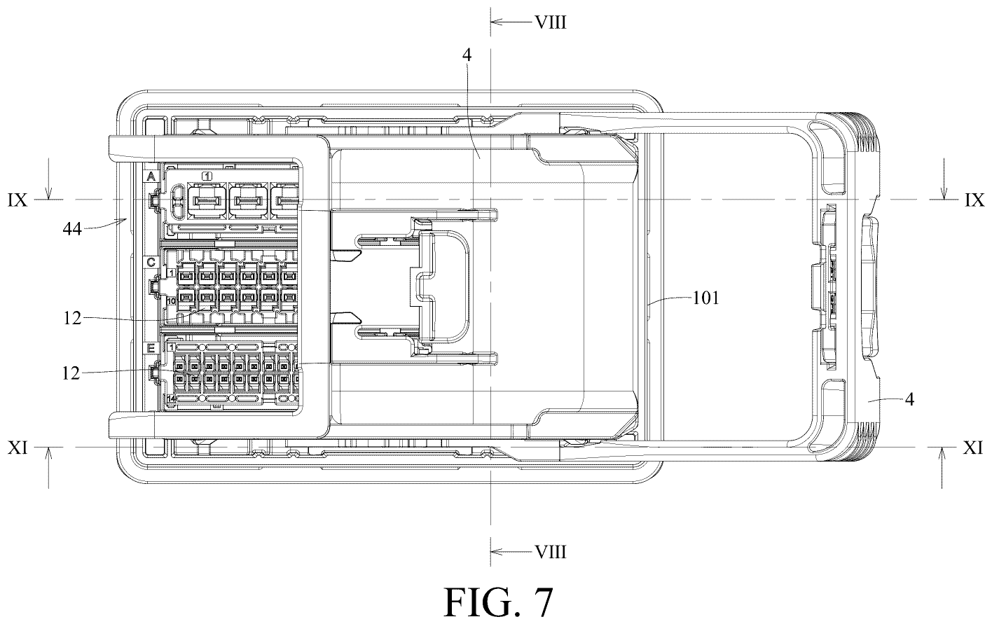

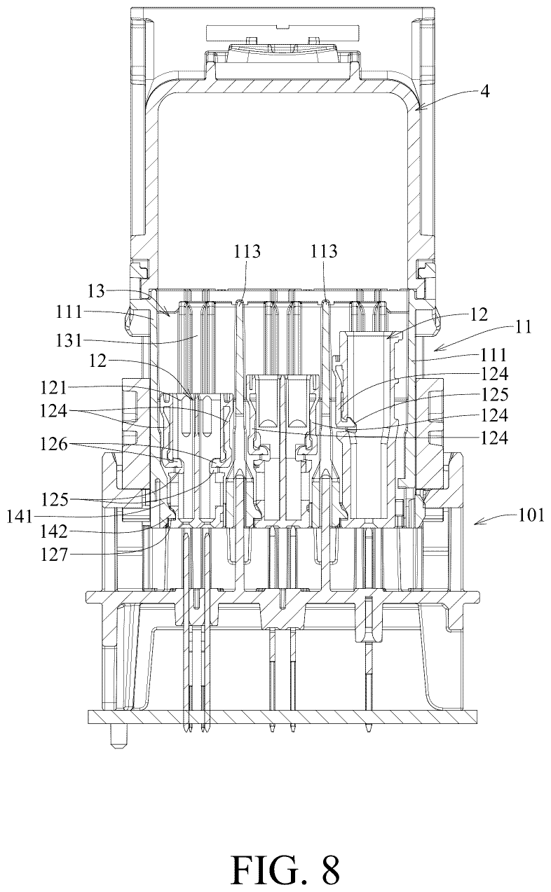

Referring to FIG. 4 to FIG. 9, in addition, each terminal module 12 further includes a latching arm 124 and a latching groove 125 which are provided to at least one of two opposite sides of the insulative body 121, as shown in FIG. 8, in the present embodiment, only one side of the two opposite sides of the insulative body 121 of each of some of the terminal modules 12 is provided with the latching arm 124 and the latching groove 125, the two opposite sides of the insulative body 121 of each of some of the terminal modules 12 each are provided with the latching arm 124 and the latching groove 125. The latching arm 124 has a tip hook 126 which is toward the latching groove 125 of the insulative body 121 and is used to latch into the latching groove 125. The latching arm 124 is in form of elastic plate structure and a top end of the latching arm 124 is integrally connected to a position of the insulative body 121 which is close to a top of the insulative body 121, that is, close to a position of the insulative body 121 where the wire 103 extends into the insulative body 121, a bottom end of the latching arm 124 is formed with the tip hook 126, and a position of the latching groove 125 is positioned below the latching arm 124, as shown in FIG. 8, when the terminal module 12 is received in the receiving chamber 13, the latching arm 124 approaches the insulative body 121, and the tip hook 126 latches into the latching groove 125, at this time, as shown in FIG. 9, by that the tip hook 126 latches into the latching groove 125, the tip hook 126 may stop in a path that the terminal 122 displaces upwardly, which thus avoids the terminal 122 being detached upwardly from the insulative body 121 due to a relationship that an external force is unexpectedly subjected.

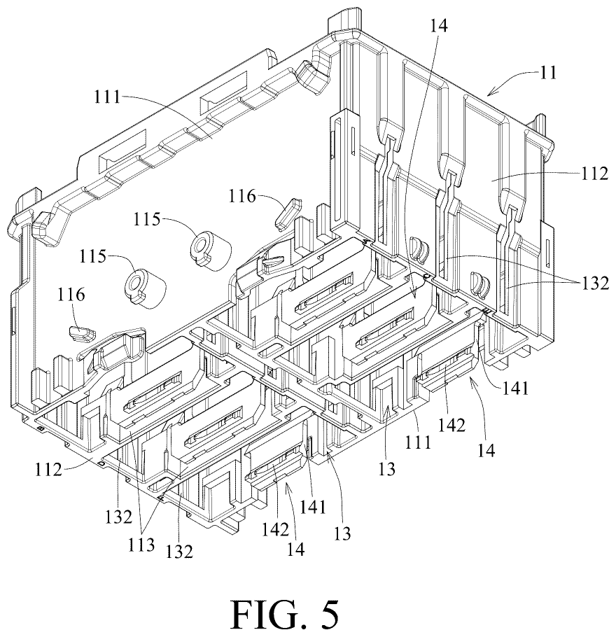

In addition to the aforementioned structure, in order to provide robustness that the terminal module 12 is received in the receiving chamber 13 of the connector housing 11, the connector housing 11 further includes position-limiting structures 14 which each are provided to each receiving chamber 13, and the terminal module 12 further includes a position-limiting portion 127 which is used to cooperate with the position-limiting structure 14. In the present embodiment, each position-limiting structure 14 includes an elastic plate 141 and a position-limiting protrusion 142 protruding from the elastic plate 141, and the position-limiting portion 127 of the terminal module 12 is a recessed groove which is formed to be recessed from an outer surface of the insulative body 121, and in the present embodiment, the position-limiting structure 14 and the position-limiting portion 127 make the connector housing 11 and the terminal module 12 interfere and cooperate with each other in the front-rear direction, the position-limiting structures 14 are provided to an inner surface of one of the two side walls 111 of the connector housing 11 and inner surfaces of the first partitioning walls 113, that is to say, the side wall 111 and the first partitioning walls 113 each are connected with the elastic plate 141 of the position-limiting structure 14 and may be actuated to elastically displace, and the position-limiting portion 127 is recessed from a front surface of the insulative body 121 and may allow the position-limiting protrusion 142 of the corresponding position-limiting structure 14 to latch therein and interfere therewith, when the terminal module 12 is received in the receiving chamber 13 of the connector housing 11, the position-limiting structure 14 cooperates with the position-limiting portion 127, that is, the position-limiting protrusion 142 of the position-limiting structure 14 latches into the corresponding position-limiting portion 127, which may limit the terminal module 12 to displace upwardly, avoid the terminal module 12 being unexpectedly detached upwardly from the receiving chamber 13. And in the present embodiment, the position-limiting structure 14 and the position-limiting portion 127 are respectively close to the bottom of the connector housing 11 and a bottom of the terminal module 12, when the position-limiting relationship between the position-limiting structure 14 and the position-limiting portion 127 needs to be released, as shown in FIG. 5, the elastic plate 141 of the position-limiting structure 14 is actuated at the bottom of the connector housing 11, the position-limiting protrusion 142 may withdraw from the position-limiting portion 127 of the terminal module 12, the position-limiting relationship between the position-limiting structure 14 and the position-limiting portion 127 is released.

Referring to FIG. 1, FIG. 3 and FIG. 10, the cover 4 is used to be mounted to and cover a top of the connector housing 11 of the connector 1, and includes a pair of side plates 41, a top plate 42 which connects the side plates 41, and a locking structure 43 which is provided to the top plate 42, and the side plates 41 define an opening portion 44 therebetween, the opening portion 44 extends by an angle range (as shown in FIG. 10), and allows the wires 103 to extend out of the opening portion 44 from different angles in the angle range. In the present embodiment, the opening portion 44 is an angle range A which extends from a horizontal direction by an elevation of 90 degrees, in other words, the opening portion 44 may be deemed to include a side opening region 441 and a top opening region 442 which are communicated with each other to be in form of L-shape, and the top plate 42 is adjacent to the top opening region 442, and each side plate 41 is provided with multiple holes 411 which are distributed to different positions from the side opening region 441 to the top opening region 442, the holes 411 are used to allow partitioning elements (for example, rods or ties may pass through the corresponding holes 411 of the two side plates 41 front and rear) pass through the holes 411 of the two side plates 41, so as to limit directions of the wires 103 which extend out of the opening portion 44. The distributed positions of the multiple holes 411 may be distributed to positions at angles of 0 degrees, 45 degrees and 90 degrees in the aforementioned angle range.

The locking structure 43 includes an elastic pressing plate 431 which is provided to the top plate 42 and a first locking portion 432 and a second locking portion 433 which are provided to a top surface of the elastic pressing plate 431, and the second locking portion 433 is adjacent to the top opening region 442 of the opening portion 44 relative to the first locking portion 432. In the present embodiment, the first locking portion 432 is a stopping block, and the stopping block has a stopping surface 432a which faces the top opening region 442, the second locking portion 433 includes two protruding blocks 433a which are spaced apart from each other front and rear.

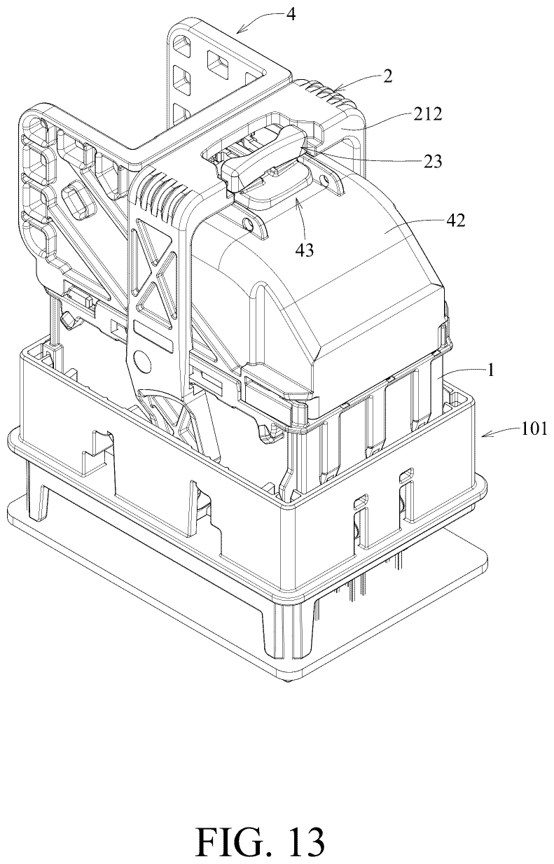

Referring to FIG. 4, FIG. 10, FIG. 12 and FIG. 13, the lever 2 is provided to the connector housing 11 and is operable to rotate relative to the connector housing 11 to a pre-mounting position where the lever 2 is away from the cover 4 and a pressing position where the lever 2 presses against the cover 4. In the present embodiment, the lever 2 includes a body 21, two driving elements 22 and a locking member 23 which are provided to the body 21, and a third locking portion 213 which is provided to the body 21. The two driving elements 22 each are used to be mounted to one of the connecting axles 115 of the each side wall 111, so as to make the body 21 be capable of being operated to rotate relative to the connector housing 11. Each driving element 22 includes a driving gear portion 221 and a driving mesh portion 222. The body 21 of the lever 2 substantially is in form of U-shape and includes two arm portions 211 and a beam portion 212 which connects the two arm portions 211, the two driving elements 22 are respectively formed to tips of the two arm portions 211, where, the driving gear portion 221 and the driving mesh portion 222 are respectively positioned to opposite sides of the tip of the arm portion 211. The driving gear portion 221 specifically may be a teeth row structure which is distributed along an arc, the driving mesh portion 222 is a tooth space structure. In the present embodiment, the third locking portion 213 is a local plate portion of the beam portion 212 of the body 21, the locking member 23 is operated to move so as to be provided on the local plate portion.

The two driven elements 3 each are mounted to the other of the connecting axles 115 of the each side wall 111, are used to respectively mesh the two driving gear portions 221 of the lever 2 for transmission, so, the two connecting axles 115 on each side wall 111 respectively sheathe one driving element 22 of the lever 2 and one driven element 3. Each driven element 3 includes a block body 31 which is used to sheathe the connecting axle 115, a driven gear portion 32 which is provided to the block body 31 and is used to mesh the driving gear portion 221 and a driven mesh portion 33 which is provided to the block body 31. In the present embodiment, the driven gear portion 32 and the driven mesh portion 33 are respectively provided to opposite side edges of the block body 31. Specifically, the driven gear portion 32 may be a teeth row structure distributed along an arc, the driven mesh portion 33 is a tooth space structure. When the connector 100 inserts into the mating connector 101, as shown in FIG. 12, the driving mesh portion 222 of the lever 2 and the driven mesh portion 33 which are positioned to the connector 100 respectively mesh the two mating mesh portions 58, so, transmission between the driving element 22 of the lever 2 and the driven element 3 which are interposed between the connector 100 and the mating connector 101 is stabler. In an embodiment, the driving mesh portion 222 of the driving element 22 and the driven mesh portion 33 of the driven element 3 each may be a tooth-profile structure, the two mating mesh portions 58 each may be a tooth space structure.

When the lever 2 is operated to rotate relative to the connector housing 11, the driving gear portion 221 of the lever 2 brings the driven gear portion 32 of the driven element 3 to rotate, so that the lever 2 is capable of rotating to the pre-mounting position or the pressing position. As shown in FIG. 12, in the pre-mounting position, the lever 2 entirely is substantially in an oblique direction, the beam portion 212 is away from the cover 4 and is close to one of the two connecting walls 112 of the connector housing 11; in the pressing position, as shown in FIG. 13, the lever 2 entirely is substantially in the vertical direction, and the beam portion 212 is close to the locking structure 43 on the top plate 42 of the cover 4.

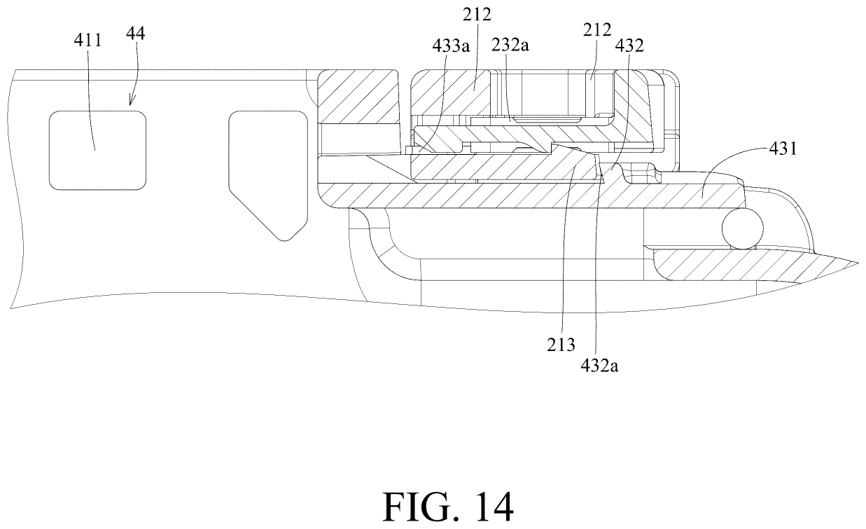

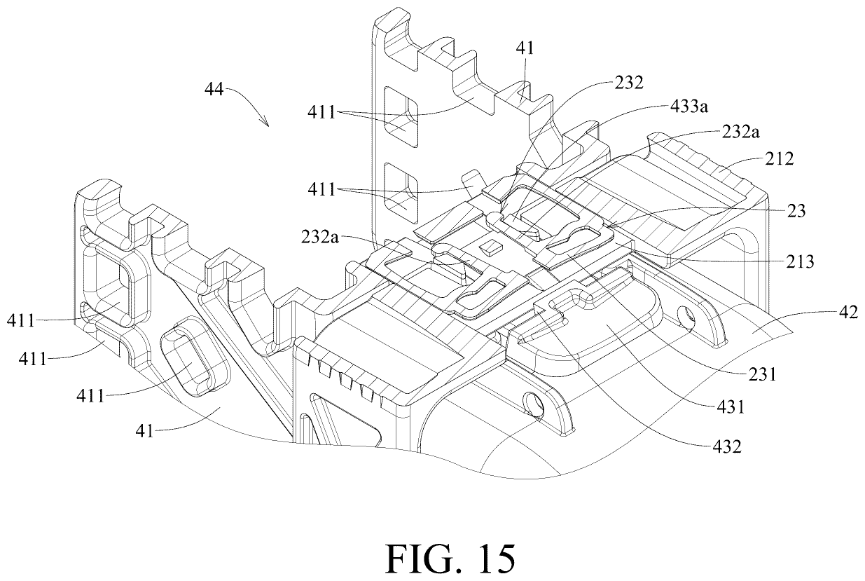

Referring to FIG. 1, FIG. 13 to FIG. 15, the locking member 23 of the lever 2 includes a locking body 231 which is movably provided to the beam portion 212 of the lever 2 and a fourth locking portion 232 which is provided to the locking body 231. The fourth locking portion 232 includes a pair of elastic latching hooks 232a which are spaced apart from each other front and rear. When the lever 2 is rotated to the pressing position, firstly, as shown in FIG. 14, when the third locking portion 213 (that is, the local plate portion) of the beam portion 212 passes over the first locking portion 432 on the top surface of the elastic pressing plate 431 and abuts against the stopping surface 432a, at this time, by that the first locking portion 432 stops the third locking portion 213, the lever 2 may be limited in a direction that the lever 2 reversely rotates back to the pre-mounting position to be stopped by the first locking portion 432, thereby making the lever 2 in a first locking state. Next, when the locking member 23 is continuously pushed toward the beam portion 212 to rotate and displace, as shown in FIG. 15, the two elastic latching hooks 232a of the fourth locking portion 232 pass through the two protruding blocks 433a of the second locking portion 433 and latch to the two protruding blocks 433a respectively, the lever 2 may be in a second locking state, which functions that a more further locking effect of the fourth locking portion 232 of the locking member 23 on the second locking portion 433, makes the lever 2 be capable of more stably be locked in the pressing position. On the contrary, when the locking of the lever 2 needs to be released, by that the locking member 23 is reversely pushed to displace, the two elastic latching hooks 232a of the fourth locking portion 232 withdraw the latching with the two protruding blocks 433a of the second locking portion 433, at the same time the elastic pressing plate 431 of the locking structure 43 is pressed down, so as to make the first locking portion 432 not stop the third locking portion 213, the locking effect between the lever 2 and the locking structure 43 may be released, in turn the lever 2 may be rotated to the pre-mounting position.

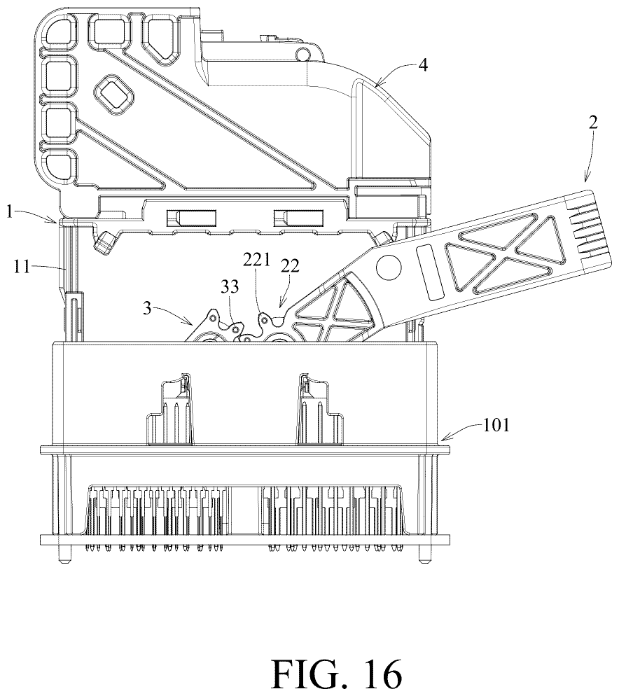

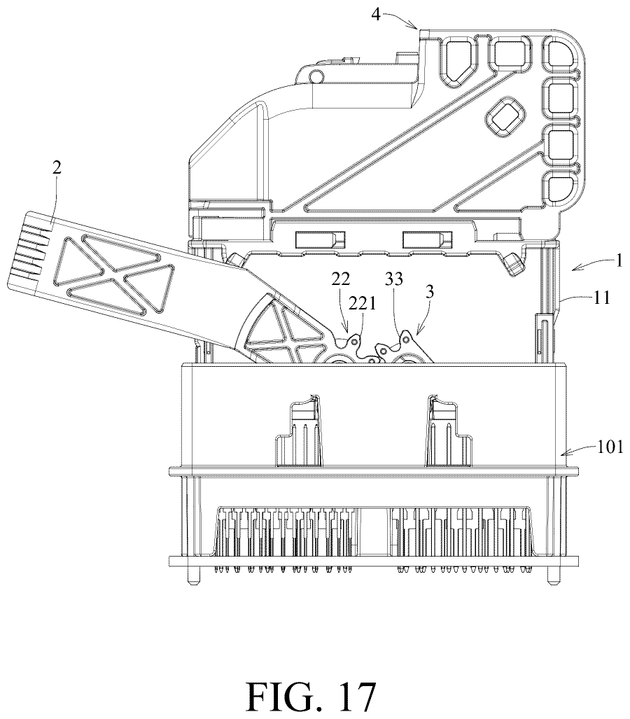

Referring to FIG. 12, FIG. 16 and FIG. 17, as described in the aforementioned content, because the connecting axles 115 of the side wall 111 of the connector housing 11 employ a symmetric arrangement, for example, if the symmetry axis 110 is taken as a reference, each side wall 111 may be deemed to include two halves which are respectively positioned to a left side and a right side of the symmetry axis 110 and are symmetric with respect to the symmetry axis 110, each half of each side wall 111 contains one connecting axle 115, so the connecting axles 115 allow the lever 2 to be capable of being selectively provided to one of the two halves and allow the driven element 3 to be provided to the other of the two halves, that is to say, regardless of the two driving elements 22 of the lever 2 sheathing connecting axles 115 on any one sides (the same right sides or the same left sides) of the two side walls 111, the two driven elements 3 may sheathe other sides of the two side walls 111 and smoothly mesh the two driving elements 22 respectively, so that the lever 2 may be selectively assembled to be positioned at a right side or a left side of the entire connector 1, in addition, the connector 1 and the cover 4 engaged with the connector 1 also may selectively insert into the mating connector 101 with the opening portion 44 of the cover 4 being toward the left as shown in FIG. 16 or the opening portion 44 of the cover 4 being toward the right as shown in FIG. 17, furthermore, the stopping protrusions 116 may be used to allow the lever 2 to abut thereagainst in the pre-mounting position regardless of the lever 2 being assembled to be positioned to the right side or the left side of the connector 1.

In conclusion, the present disclosure at least has the flowing effects and can indeed attain the objects of the present disclosure.

Firstly, by provision of the guiding rib 120 of the terminal module 12, the guiding groove 131 and the opening segment 132 of the connector housing 11 and in cooperation with the mating guide groove 57 of the mating connector 101, when the guiding rib 120 of the terminal module 12 may be placed into the receiving chamber 13 of the connector housing 11 and when the connector 100 inserts into the mating guide groove 57 of the mating connector 101, guiding functions may be played.

Secondly, with the two connecting axles 115 of the connector housing 11 of each side wall 111 employ a symmetric arrangement, in a case that the connector housing 11 and the terminal module 12 are not changed, it may only need to adjust the lever 2, the driven elements 3 and the cover 4 in the left-right direction, the requirement on a wire exiting direction toward the right or the left may be rapidly met. Additionally, in cooperation with the holes 411 of the two side plates 41 of the cover 4 which are distributed at different angles, it also may more flexibly adjust the wire exit direction of the wires 103.

Thirdly, by that the position-limiting structure 14 of the connector housing 11 cooperates with the position-limiting portion 127 of the terminal module 12, it may provide robustness of the terminal module 12 received in the receiving chamber 13 of the connector housing 11.

However, the above description is only for the embodiment of the present disclosure, and it is not intended to limit the claims of the present disclosure, and the simple equivalent changes and modifications made according to the claims and the contents of the specification are still included by the claim.

What is claimed is:

1. A connector assembly, comprising:
a connector, comprising:
a plurality of terminal modules, each terminal module being provided with at least one guiding rib protruding therefrom; and
a connector housing forming a plurality of receiving chambers which are used to respectively receive the plurality of terminal modules, each receiving chamber being formed with a guiding groove and an opening segment which correspond to the guiding rib; and
by that the guiding groove guides the guiding rib of the terminal module, each terminal module being received in one receiving chamber, and the guiding rib at least partially extending out of the opening segment.

2. The connector assembly of claim 1, further comprising:
a mating connector, the mating connector being formed with a plurality of mating regions which are respectively used to correspond to the plurality of terminal modules respectively in the plurality of receiving chambers, each mating region being formed with a mating guide groove which corresponds to the guiding rib.

3. The connector assembly of claim 1, wherein
the opening segment of each receiving chamber has a tip,
the guiding rib of the terminal module abuts against the tip of the opening segment.

4. The connector assembly of claim 1, wherein
the connector housing comprises two side walls which face each other, two connecting walls which connect the two side walls and a plurality of partitioning walls,
the plurality of partitioning walls are provided between the two side walls and the two connecting walls, the plurality of partitioning walls and the two side walls and the two connecting walls cooperate with each other to define the plurality of receiving chambers which are used to respectively receive the plurality of terminal modules,
the guiding grooves and the opening segments are provided to the two connecting walls and the plurality of partitioning walls and correspond to each other.

5. The connector assembly of claim 1, wherein
each terminal module is provided with the two guiding ribs protruding therefrom, the two guiding ribs respectively protrude from two opposite sides of the terminal module, each receiving chamber of the connector housing has the two guiding grooves and the two opening segments.

6. The connector assembly of claim 1, wherein
each terminal module comprises an insulative body and terminals which are mounted to the insulative body and are used to be connected with wires respectively,
the connector assembly further comprises a cover which is mounted to the connector housing, the cover comprises a pair of side plates, and the pair of side plates define an opening portion therebetween, the opening portion extends by an angle range and allows the wires to extend out of the opening portion from different angles in the angle range.

7. The connector assembly of claim 6, wherein
each side plate is provided with multiple holes, which are in different positions, along the angle range,
the holes are used to allow partitioning elements to pass through the holes of the side plates so as to limit directions of the wires which extend out of the opening portion.

8. The connector assembly of claim 7, wherein
the opening portion comprises a side opening region and a top opening region which are communicated with each other to be in form of L-shape,
the multiple holes are distributed from the side opening region to the top opening region.

9. The connector assembly of claim 1, wherein
each terminal module comprises an insulative body and a latching arm and a latching groove which are provided to at least one of two opposite sides of the insulative body,
each latching arm has a tip hook which is toward the latching groove of the insulative body and is used to latch into the latching groove.

10. The connector assembly of claim 6, wherein
each receiving chamber of the connector housing is formed with a position-limiting structure,
each terminal module further comprises a position-limiting portion which is formed to an outer side of the insulative body,
when the terminal module is received in the receiving chamber, the position-limiting structure and the position-limiting portion cooperate with each other to limit the terminal module to be detached from the receiving chamber.

11. A connector assembly, comprising:
a connector, comprising:
a connector housing comprising two side walls which face each other, each side wall being provided with two connecting axles protruding therefrom and spaced apart from each other, the two connecting axles being symmetric with respect to a symmetry axis which passes through between the two connecting axles;
a plurality of terminal modules which are provided to the connector housing;
a lever which is provided to the connector housing and is capable of being operated to rotate relative to the connector housing, the lever comprising two driving elements which each are used to be mounted to one of the two connecting axles of the each side wall, each driving element comprising a driving gear portion; and
two driven elements which each are used to be provided to the other of the two connecting axles of the each side wall, each driven element comprising a driven gear portion which is used to mesh the driving gear portion.

12. The connector assembly of claim 11, wherein
each side wall comprises two halves which are symmetric with respect to the symmetry axis, each half contains one connecting axle,
the two connecting axles allow the lever to be capable of being selectively provided to one of the two halves and allow the driven element to be provided to the other of the two halves.

13. The connector assembly of claim 11, further comprising:
a mating connector, the mating connector comprising two outer side walls which are spaced apart from each other, and four mating mesh portions which are provided to the two outer side walls, each outer side wall being provided with the two mating mesh portions, and
each driving element of the lever further comprising a driving mesh portion,
each driven element further comprising a driven mesh portion,
the two mating mesh portions of each outer side wall being respectively used to mesh the driving mesh portion of the driving element and the driven mesh portion of the driven element.

14. The connector assembly of claim 13, wherein
the driving mesh portion of the driving element and the driven mesh portion of the driven element each are one of a tooth-profile structure and a tooth space structure,
the two mating mesh portions each are the other of the tooth-profile structure and the tooth space structure.

15. The connector assembly of claim 11, wherein
each terminal module comprises an insulative body and terminals which are mounted to the insulative body and are used to be connected with wires respectively,
the connector assembly further comprises a cover which is mounted to the connector housing, the cover comprises a pair of side plates, and the pair of side plates define an opening portion therebetween, the opening portion extends by an angle range and allows the wires to extend out of the opening portion from different angles in the angle range.

16. The connector assembly of claim 15, wherein
each side plate is provided with multiple holes, which are in different positions, along the angle range,
the holes are used to allow partitioning elements to pass through the holes of the side plates so as to limit directions of the wires which extend out of the opening portion.

17. The connector assembly of claim 16, wherein
the opening portion comprises a side opening region and a top opening region which are communicated with each other to be in form of L-shape,
the multiple holes are distributed from the side opening region to the top opening region.

18. The connector assembly of claim 11, wherein
each side wall of the connector housing is further provided with two stopping protrusions protruding therefrom and spaced apart from each other,
the two connecting axles are positioned between the two stopping protrusions, and the two stopping protrusions are symmetric with respect to the symmetry axis.

19. The connector assembly of claim 11, wherein
the connector further comprises a cover which is mounted to the connector housing, the cover comprises a locking structure,
the lever further comprises a body and a locking member provided to the body, and the lever is operable to rotate relative to the connector housing to a pre-mounting position where the lever is away from the cover and a pressing position where the lever presses against the cover, when the lever is in the pressing position, the lever is capable of being in a first locking state, and the locking member is capable of being operated to cooperate with the locking structure so that the lever is further in a second locking state.

20. The connector assembly of claim 19, wherein
the cover further comprises a pair of side plates and a top plate connecting the two side plates,
the locking structure is provided to the top plate, and comprises an elastic pressing plate which is provided to the top plate and a first locking portion and a second locking portion which are provided to the elastic pressing plate,
the lever further comprises a third locking portion which is provided to the body,
the locking member comprises a locking body which is movably provided to the lever and a fourth locking portion which is provided to the locking body,
when the lever is operated to rotate to be in the pressing position and the lever is in the first locking state, the third locking portion of the locking member is stopped by the first locking portion in a direction that the third locking portion of the locking member rotates back to the pre-mounting position,
when the locking member is operated to displace to make the fourth locking portion latch to the second locking portion, the lever is in the second locking state.
